(19) United States
(12) Patent Application Publication
(10) Pub. No.: US 2006/0221017 A1
(43) Pub. Date: Oct. 5, 2006

(54) Apparatus and a method for displaying colors or color patterns based on time and other information sources

(76) Inventor: Ming Fang, Princeton Junction, NJ (US)

Correspondence Address: Mr. Walter J. Tencza Jr., Suite 3, 10 Station Place, Metuchen, NJ, 08840, US

(21) Appl. No.: 11/172,255

(22) Filed: Jun. 30, 2005

Related U.S. Application Data
(60) Provisional application No. 60/665,935, filed on Mar. 29, 2005.

(51) Int. Cl. G09G 3/32

(52) U.S. Cl. 345/83

(57) ABSTRACT

An apparatus and a method are disclosed comprising a timepiece, a color display device, and an information source device with one or more information sources. The color display device may display different colors or color patterns depending on time and the one or more information sources, such as a luckiness index and personal information. The information source device comprised of a fixed, removable or remote storage device may provide the one or more information sources. The color display device may be comprised of display screens of electronic devices, such as computers, hand-held, cellular phones, and portable media players, as well as objects illuminated by a plurality of light sources.

### CROSS REFERENCE TO RELATED APPLICATIONS

This application claims the priority benefit of Provisional Patent Application Ser. No. 60/665,935, filed on Mar. 29^{th}, 2005, by Ming Fang, resident at 4 Barrington Drive, Princeton Junction, N.J. 08550.

### FIELD OF THE INVENTION

This invention relates to the field of systems and methods for displaying colors or color patterns based on time and one or more information sources.

### BACKGROUND OF THE INVENTION

Many devices can display time. The term “time” as used in the present invention includes both regular time information such as a time of day, or a particular hour, minute, or second, and calendar information, such as a particular day, week, month, or year. Clocks and watches are common devices used to display time. Computers, telephones, and many home and office electronic devices may also display time.

There is no known apparatus that can display time and colors or color patterns based on time and one or more information sources.

### SUMMARY OF THE INVENTION

The present invention, in one or more embodiments, provides an apparatus with a timepiece and a color display device that displays different colors or color patterns based on time and one or more information sources.

In at least one embodiment of the present invention the apparatus is comprised of a device that can display time and a color display device that shows different colors or color patterns based on time and one or more information sources. The device that can display time may be a cellular phone, a regular phone, a personal digital assistant (PDA), a portable music player, a portable computer, a personal computer, a radio with a clock, a digital camera, a video camera, a video player, or any other electronic device with a built-in timing device. Such a device may not primarily be used as a timepiece, but time display is one of the functions the device provides.

In at least one embodiment of the present invention the apparatus is comprised of a timepiece having a time display panel and a color display device that controls the background color and/or the foreground color of the time display panel based on time and one or more information sources. When the time display panel is illuminated with one or more green or red colored lights, the time display panel appears to have a green or red background, respectively. The background illumination color may also be kept unchanged and the foreground color may be changed instead, such as a color for time display characters.

In at least one embodiment of the present invention the apparatus is comprised of a device that can display time and a color display device that controls the background color or the foreground color of its display based on time and one or more information sources. A device that can display time may include a cellular phone, a regular phone, a personal digital assistant (PDA), a portable music player, a portable computer, a personal computer, a radio with a clock, a digital camera, a video camera, a video player, or any other electronic device with a built-in timing device. In general, such device has a display panel that can display time and a wide range of other types of information.

In at least one embodiment of the present invention the apparatus is comprised of a timepiece, a color display device and a storage device. The color display device displays colors or color patterns based on time from the timepiece and one or more information sources provided by the storage device.

In at least one embodiment of the present invention the apparatus is comprised of a timing device, a color display device and a storage device. The color display device displays different colors or color patterns based on time from the timing device and one or more information sources provided by the storage device.

The color display device according to the present invention may be integrated with the timepiece or may be a part of a device that can display time.

Alternatively, the color display device according to the present invention may separate one from the timepiece or a device that can display time. However, in that case, the color display device may be connected to the timepiece or the device that can display time so that the color display device can get time information.

The color display device according to the present invention may display different colors, spatial color patterns, temporal color patterns, and different spatial and temporal color patterns.

The color display device may be comprised of one or more color displays. The one or more color displays may have different sizes and shapes, and may be placed at different locations. Depending on apparatus design and settings, the one or more color displays may be used to display:

(a) Colors or color patterns for one or more days of the week such as Monday, Tuesday, etc.;

(b) Colors or color patterns for one or more hours of the day, such as 5:00 p.m., etc. (c) Colors or color patterns for one or more subjects; and

(d) Colors or color patterns for combinations of one or more days of the week, hours of the day, and subjects.

The storage device according to the present invention may be a fixed one that is built into an apparatus according to the present invention.

The storage device according to the present invention may be a removable one that can be inserted into or removed from other components of an apparatus according to the present invention. The removable storage device provides the capability for software and stored information upgrade.

The storage device according to the present invention may be a remote one that can be accessed by other components of an apparatus according to the present invention via a wired or a wireless communication line. The remote storage device also provides the capability for easy software and stored information upgrade.

The storage device according to the present invention may store and provide one or more information sources. At least one information source may provide a luckiness index for every given time interval within a given time range. A given time interval may for example be one minute, thirty minutes, one hour, two hours, twenty four hours, one week, or one month. A given time range may for example be one year, two years or ten years. The luckiness index may be compressed and/or encrypted for smaller size and/or better data security.

In at least one embodiment of the present invention the apparatus is further comprised of a color mode selection device with which a user can select different pre-set color modes depending on his/her personal preference.

The apparatus may be further comprised of a date selection device with which a user can select a different date so that the user can see the color or the color pattern associated with the selected date.

The apparatus may be further comprised of a time selection device with which a user can select a different time so that the user can see the color or the color pattern associated with the selected time.

The apparatus may be further comprised of a personalization device. The personalization device may be used to personalize the apparatus based on some personalization inputs. The personalization inputs may be comprised of a country code so that all holidays in a given country may be used to show special holiday colors or color patterns. The personalization inputs may further be comprised of a religion code so that each main religion in the world may be represented by one religion code. The religion code may be used by the personalization device to show special colors or color patterns for all religious holidays or religious events and/or activities. The personalization inputs may further be comprised of a sex code so that it can display male or female oriented colors or color patterns. The personalization inputs may further be comprised of a birthday code of the owner of the apparatus so that the luckiness index may further be personalized.

A “Test My Luck” button may also be provided with which a user can test his or her own luck by seeing a final color displayed, that may be associated with a luckiness level, or by predicting a final color or a final color sequence displayed by the apparatus.

The present invention also includes a method of combining a timepiece and a color display device so that the combined device can display time and different colors or color patterns based on time and one or more information sources.

A method of combining a device with a timing device and a color display device is also provided so that the combined device can display different colors or color patterns based on time and one or more information sources.

The present invention also includes a method of using a storage device to provide one or more information sources needed for determining the display colors or color patterns. The storage device may be a fixed one, a removable one, or a remote one.

The present invention also includes a method of pressing a button to initiate a luck test, displaying a plurality of colors within a certain period of time, using a random process to select a final color, and displaying the final color that may be associated with a luckiness index. The luckiness level means that a user can see the final color after pressing the button and will know the luckiness based on the final color shown.

The present invention also includes a method of predicting a final color, pressing a button to initiate a luck test, displaying a plurality of colors within a certain period of time, using a random process to select a final color, displaying the final color, and determining a luckiness level depending on if and/or how well the predicted and the displayed final color matches.

The present invention also includes a method of predicting a sequence of several final colors, pressing a button to initiate a luck test, displaying a plurality of colors within a certain period of time, using a random process to select a final color, displaying the final color; repeating the process starting with the button press for several times, and determining a luckiness level depending on if and/or how well the predicted and the actually displayed final color sequence matches.

The plurality of colors may be displayed in a periodic way.

The plurality of colors may be displayed in a periodic way with a decreased switching speed between different colors.

In addition to showing time, an apparatus in accordance with an embodiment of the present invention may also display a solid color of yellow for normal working days, a solid green color for weekends, as well as some special colors or color patterns for holidays. For holidays, it may display a pink or red color for Valentine's Day, a combination of red, blue and white colors for Presidents Day and July, 4^{th}, an orange color for Halloween, and a combination of red and green colors for Christmas. In addition to special holiday color or color pattern displays, we may use special colors or color patterns for displaying other information that may change over time. For example, we may believe that some particular days or times are the lucky ones while some other days or times may be considered to be less lucky. Unfortunately, there is no known easy way to show luck that changes over time. However, if we can associate certain colors or color patterns with luckiness, such as green for lucky, blue for normal, and brown or black for unlucky, we may easily show luckiness with such a color display. A user can easily understand the particular meaning or the luckiness of a given time or day by seeing a particular color or a particular color pattern displayed by an apparatus according to the present invention.

### BRIEF DESCRIPTION OF THE DRAWINGS

FIG. 1A is a perspective view schematically illustrating the overall structure of one embodiment of the present invention with a timepiece, a color display device that can display different colors or color patterns based on time and one or more information sources, and a storage device that provides the one or more information sources;

FIG. 1B is a perspective view illustrating a cylinder-shaped color display device;

FIG. 1C is a perspective view illustrating a cubical color display device;

FIG. 1D is a frontal view illustrating a bullet head shaped color display device;

FIG. 1E is a frontal view illustrating a funny face shaped color display device;

FIG. 2 is a perspective view schematically illustrating the overall structure of one embodiment of the present invention with a cover device that can enhance the visual appearance of the colors or color patterns shown by the color display device;

FIG. 3 is a perspective view schematically illustrating the overall structure of one embodiment of the present invention with a plurality of accessory holders and USB connectors;

FIG. 4 is a perspective view schematically illustrating the overall structure of one embodiment of the present invention with a test my luck button;

FIG. 5 is a frontal view schematically illustrating a typical time display;

FIG. 6 is a frontal view schematically illustrating a typical calendar display;

FIG. 7 is a block diagram schematically illustrating the typical devices that may be used for one embodiment of the present invention;

FIG. 8 is a signal flow diagram schematically illustrating the steps for determining a color to be displayed by a color display device; and

FIG. 9 is a signal flow diagram schematically illustrating the steps for generating colors to be displayed by a color display device after a “Test My Luck” button has been pressed.

### DETAILED DESCRIPTION OF THE INVENTION

The present invention in one or more embodiments provides an apparatus that can display time as well as different colors or color patterns based on time and one or more information sources.

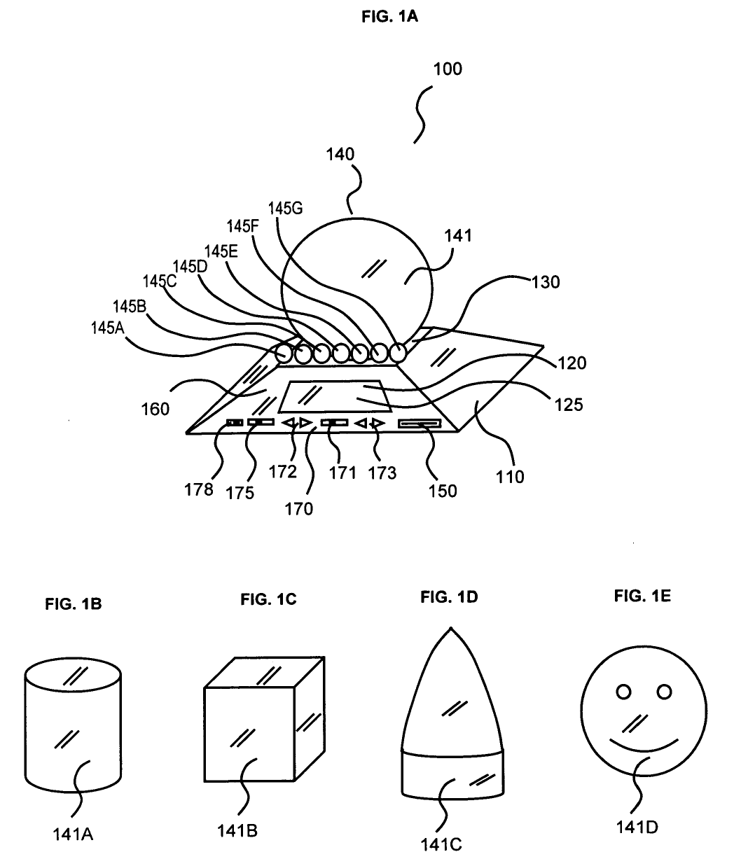

A perspective view of a system, apparatus, and method according to one embodiment of the present invention is shown in FIG. 1A. FIG. 1A shows an apparatus 100 comprised of a base 110, a timepiece 120, a lighting device 130, a color display device 140, a storage device 150, a control device 160, and a user interface device 170. The base 110 hosts devices 120, 130, 140,150, 160, and 170. Timepiece 120 is preferably a digital timepiece. Timepiece 120 is comprised of a display screen 125. Display screen 125 is capable of displaying time and calendar information. In addition, display screen 125 may be comprised of one or more small display screens. Each of the one or more small display screens such as display screen 125 may show time for one time zone. It is sometimes very useful for international traders or business people to have two or more displays showing times from two or more different time zones so that they can always know the time in one or more remote cities where their businesses or business partners are relocated. Timepiece 120 may be a regular quartz based digital timepiece. It may also be a radio-controlled one so that it can automatically synchronize with the National Institute of Standards and Technology's radio signal. A radio-controlled timepiece provides the most accurate timekeeping technology available today. The lighting device 130 may be comprised of a plurality of light sources, such as Light Emission Diodes (LEDs). The plurality of light sources may provide light in various colors. Lighting device 130 emits light to illuminate color display device 140. Color display device 140 may be comprised of a plurality of large and small displays, such as displays 141 and 145A, 145B, 145C, 145D, 145E, 145F, and 145G. Since lighting device 130 is relocated inside or underneath the display device 140, it cannot be seen directly in FIG. 1A. Color display device 140 is in general transparent or semi-transparent so that the light from the lighting device 130 may shine through it. The large and small displays of the color display device 140 may also take various shapes. Devices 141A, 141B, 141C, and 141D shown in FIGS. 1B, 1C, 1D, and 1E, respectively, are some examples of a large display to be used for or instead of the large display 141. In general, the large display 141 may be ball-shaped, egg-shaped, cylinder-shaped, pyramid-shaped, or bullet-shaped. Other regular or irregular shapes, such as a happy face or a bull may also be used. Small displays 145A-G may also have various shapes and forms depending on application and design needs. More examples of such displays are omitted for brevity.

The plurality of large and small color displays may show colors or color patterns for a plurality of different times. For example, color display device 140 shown in FIG. 1A may be comprised of a large display 141 for displaying the color or color pattern of the current day, and for example, seven small color displays 145A-G may be used for showing colors or color patterns for the next seven days. Depending on the setting, the seven small color displays 145A-G may also be used to show colors or color patterns for the next seven hours. This enables people to foresee what is coming and plan their activity accordingly. The color displays, such as 141 and 145A-G, may also be used to display colors or color patterns for a plurality of luckiness indices for a corresponding plurality of subjects. For example, the large display 141 may display the overall luckiness index of the current day while the several small color displays 145A-G show colors or color patterns for each of a plurality of important subjects in life, such as, Love and Marriage, Health, Wealth, Business Deal, Job Move, House Move, Sport, Travel. Sometimes, a particular day or time may be a normal one overall, a lucky one for Business Deals and Wealth, normal for Sport, but unlucky for Travel. In this case, a person may want to make a financial investment or start a new business, or travel to another country or city. Some times, people may want to wait to do something until an overall lucky day or time comes, together with a lucky indication also for the subject they are most interested in. In general, the color display device 140 shown in FIG. 1A may be comprised of one or more color displays. The one or more color displays may have different sizes, shapes, and may be placed at different locations. Depending on design and settings, the one or more color displays may be used to display:

(a) Colors or color patterns for one or more days;

(b) Colors or color patterns for one or more hours;

(c) Colors or color patterns for one or more subjects; and

(d) Colors or color patterns for combinations of days, hours, and subjects.

The colors and color patterns may be associated with luckiness levels, holidays, and other special events of interest.

Storage device 150 shown in FIG. 1A may contain one or more information sources or data that are needed for the selection of display colors or color patterns. For example, all holidays or data representative of all holidays may be stored on device 150. A luckiness table or set of data may also be stored on device 150. A luckiness table is a table where luckiness information is stored for each day or even each hour or each minute for a given period of time. For example, a luckiness table or set of data may contain luckiness information for one or a plurality of calendar years. Storage device 150 may be a fixed one, a removable one or a remote one. A fixed storage device is a low-cost option but with no easy upgrade capability. Examples of such a fixed storage device are, a flash memory device, hard drives, ROM (Read Only Memory) devices. A removable storage offers easy upgrade capability. Examples of such a removable storage device are drives for accessing information stored on Floppy disks, Compact Discs (CD) or Digital Video Discs (DVD), media readers capable of accessing removable medias, such as Flash Card, CompactFlash (Trademarked), XD Picture Card (Trademarked), SmartMedia (Trademarked), Secure Digital (Trademarked), MultiMediaCard, IBM Microdrive (Trademarked), Memory Stick (Trademarked) media from Sony (Trademarked), as well as Universal Serial Bus (USB) based storage devices. All a user needs to do is to get a new removable storage media with updated information and the upgrade is done. A remote storage device offers the best upgrade capability. Examples of such a remote storage device are Internet based remote storage devices, local area networks based remote storage devices, and wide area networks based remote storage devices. However, such a device needs a network or similar connection to a remote data source server, from which up-to-date information may be downloaded.

The control device 160 of apparatus 100 is an electronic device located inside of the base 110 and therefore cannot be seen in FIG. 1A directly. Device 160 uses the current time information from timepiece 120 as well as the one or more information sources from device 150 to make the control decision about which colors or color patterns should be displayed, and control the lighting device 130 to do so.

The user interface device 170 shown in FIG. 1A may be comprised of a plurality of interface devices that enable a user to control and set preferences. Apparatus 100 may be placed in more than one working mode. For example, timepiece 120 needs to be set or adjusted to show accurate time. Therefore, apparatus 100 may have a time and day adjust mode. For international travelers or business people, a time zone selection may also be useful. In addition, apparatus 100 may have a stopwatch mode or an alarm clock mode so that timepiece 120 may also be used as a stopwatch or an alarm clock, respectively. A working mode selection device 171 shown in FIG. 1A may be used to switch among a plurality of working modes. The two adjustment devices 172 and 173 may be used to adjust different variables in different modes. For example, in the time and day adjust mode, device 172 may be used to adjust time while device 173 may be used for selecting day. In the time zone mode, both devices 172 and 173 may be used for time zone selection. Furthermore, apparatus 100 may have a review mode that can be used to allow a user to select a time or a day temporarily for reviewing or planning purposes without changing the actual time or the calendar information of the timepiece 120 permanently. The purpose of such a review mode is to allow a user to move forward or backward with day or time temporarily so that people can see if three days after today is a lucky day or an unlucky one, or if 3 P.M. is a lucky hour or not, and plan their activities accordingly. In the review mode, devices 172 and 173 may be used to select time and day, respectively. The user interface device 170 may further be comprised of a subject selection mode that can be used to select and set the subject of interest either temporarily or permanently. For example, when color displays 140 and 145A-G shown in FIG. 1A are used to display colors or color patterns for just one subject, such as Love and Marriage, people sometimes may want to see the colors or color patterns for another subject either temporarily or permanently. In this case, they can select the subject selection mode and then use devices 172 or 173 to select a desired subject so that the color display device will display colors or color patterns related to the subject. In order to meet the needs to satisfy personal and cultural preferences and differences, user interface device 170 may further be comprised of a color mode selection device 175 that switches among a plurality of available color modes. For example, the red color may be considered to be a lucky color in some Asian cultures, while the green color may suit people from other culture backgrounds much better. By switching among a plurality of available color modes using device 175, people from a wide range of culture backgrounds may find their preferred color choice for indicating lucky and unlucky times and days. Different color modes may be provided, based on geographical regions, such as North America, South America, Europe, the Middle East, and Asia, or Countries, such as the USA, Brazil, England, Germany, China, and Japan, or religions, such as Christian, Islam, and Buddhism. In addition, some standard color modes may be offered that are cultural neutral, such as a slow varying random color mode for a slowly changing random color display or a fast varying random mode for fast changing random color display of the display device 140. Since display device 140 may be comprised of large, such as 141, and small displays, such as 145A-G, more variations may be added. For example, a special random color mode may be provided that changes the random color of the large display slowly, while changing the random color of the small displays quickly. In addition, a random color mode may be provided that enables the color of the small displays in a synchronous or a synchronous way. Such modifications are also included. In order to increase design and functional flexibility and save some space or devices, the color mode selection may also be added as a new working mode to the mode selection device 171, and device 172 or device 173 may be used to do the actual color mode selection. By doing so, the total number of color modes is no longer limited by the mode switch device 175. New color modes can be added as needed and the total number of color modes is not limited by design. The user interface device 170 may further be comprised of a power switch 178 that can be used to turn on or turn off lighting device 140.

There are many standard ways to design the user interface device 170. User interface device 170 may for example use more or less control buttons. The placement of the control devices 171, 172, 173, 175, 178 may also be different from that shown, User interface device 170 may also use different interface controls, such as a dial or sticks, instead of just buttons and switches.

The base 110 shown in FIG. 1A may have various sizes, shapes and optical properties depending on design and application needs. The base 110 may be made of non-transparent or semi-transparent or transparent materials. When the whole or part of base 110 is made with semi-transparent or transparent materials, it may also be seen as a part of the color display device 140. In this case, the lighting device 130 will not only illuminate the color display device 140, but also the base 110. In a simplified design without the small displays 145A-G shown in FIG. 1A, for example, color display 141 may be used to display colors or color patterns for each hour, while the base 110 may be used to show colors or color patterns for each day, or vice versa.

The timepiece 120 shown in FIG. 1A has been placed within the base 110. It is also possible to place it within the color display device, such as color display device 140. In general, timepiece 120 can be placed anywhere in the base 110 or in the color display device 140 as long as there is sufficient space to host it.

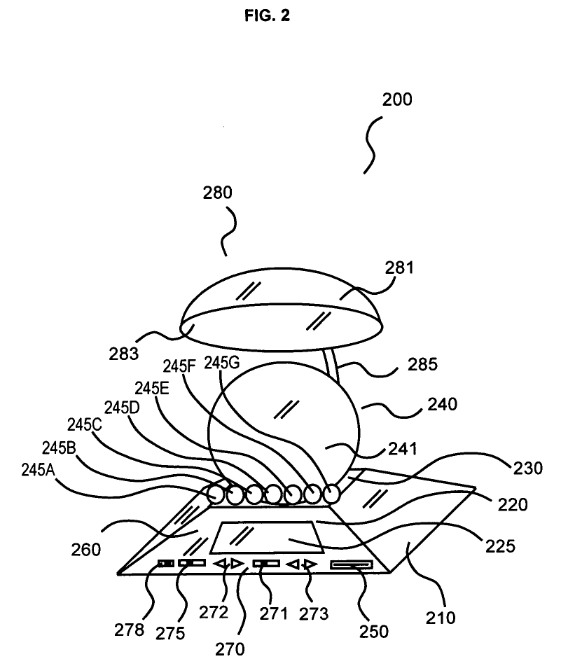

Apparatus 100 shown in FIG. 1A may be enhanced by adding a cover device that can effectively block strong light from sun or room lighting so that the colors or color patterns shown by the display device 140 may be more clear and impressive. A perspective view of a system, an apparatus, and a method according to one embodiment of the present invention with a cover device is shown in FIG. 2. FIG. 2 shows an apparatus 200 comprised of a base 210, a timepiece 220, a lighting device 230, a display device 240, a storage device 250, a control device 260, a user interface device 270, and a cover device 280. The apparatus 200 also includes devices 245A, 245B, 245C, 245D, 245E, 245F, and 245G, and devices 241, 271, 272, 273, 275, and 278. Devices 210, 220, 225, 230, 240, 241, 245A-G, 250, 260, 270, 271, 272, 273, 275, and 278 are similar to devices 110, 120, 125, 130,140, 141, 145A-G, 150, 160, 170, 171, 172, 173, 175, and 178, respectively, shown in FIG. 1. Cover device 280 is comprised of top cover 281 with an inner cover surface 283, and a flexible and elongated member 285 fixing the top cover 281 to base 210. The main utility of the cover device 280 is to block strong sun or room lighting so that the display device 240 may better show the colors or color patterns intended to be displayed. Sometimes, if the environmental lighting is too strong, it will negatively impact the visual appearance of colors or color patterns displayed on the display device 240. The top cover 281 is non-transparent so that light from sun or room lighting can be blocked effectively. In order to promote and enhance the color light from the lighting device 230, the inner surface 283 may be reflective so that light from the color display device 240 may be reflected back off of the inner surface 283. By the combination of blocking the unwanted environmental lighting and reflecting the color light from the color display device 240, more vivid and accurate colors may be shown by the color display device 240. Because the environmental lighting may change over time, the flexible and elongated member 285 is designed in such a way that the top cover 281 may easily be moved accordingly.

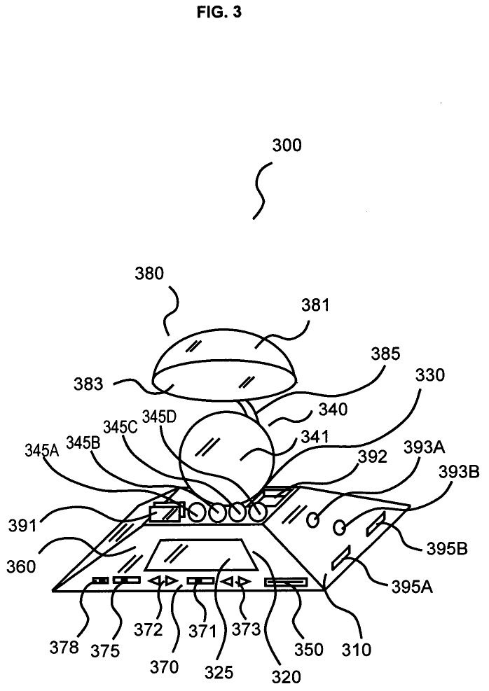

Apparatuses 100 and 200 shown in FIG. 1A and FIG. 2 may further be enhanced by adding a plurality of desktop accessory holders, and USB connectors. A perspective view of a system, an apparatus, and a method according to one embodiment of the present invention with a plurality of desktop accessory holders and USB connectors is shown in FIG. 3. FIG. 3 shows an apparatus 300 comprised of a base 310, a timepiece 320, a lighting device 330, a display device 340, a storage device 350, a control device 360, a user interface device 370, a cover device 380, and a plurality of desktop accessory holders 391, 392, 393A-B and USB connectors 395A-B. Devices 310, 320, 325, 330, 341, 350, 360, 370, 371, 372, 373, 375, 378, 380, 381, 383, and 385 are similar to devices 210, 220, 225, 230, 241, 250, 260, 270, 271, 272, 273, 275, 278, 280, 281, 283, and 285, respectively, shown in FIG. 2. Due to limited free space, display device 340 may be comprised of only four small color displays 345A, 345B, 345C, and 345D, which may be similar to devices 245A, 245B, 245C, and 245D, respectively, shown in FIG. 2. The plurality of desktop accessory holders may include a business card holder 391, a small office accessory holder 392, and two pen holders 393A-B. The total number of the desktop accessory holders, as well as their placement, may be changed depending on actual design needs. There are also two USB connectors 395A-B shown in FIG. 3. The USB connectors may provide power to some USB based portable devices, such as USB based reading lights, a USB based personal fan, USB based chargers for cell phones and music players, and USB based air purifiers or air fresheners.

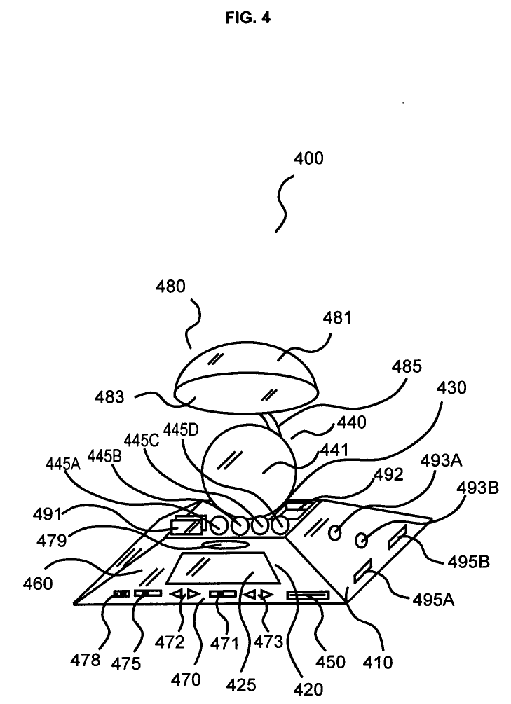

Apparatuses 100, 200, 300 shown in FIGS. 1A, 2 and 3 may be enhanced by adding a “Test My Luck” button. A perspective view of a system, an apparatus, and a method according to one embodiment of the present invention with a “Test My Luck” button is shown in FIG. 4. FIG. 4 shows an apparatus 400 comprised of a base 410, a timepiece 420, a lighting device 430, a display device 440, a storage device 450, a control device 460, a user interface device 470, a cover device 480, a plurality of desktop accessory holders 491, 492, 493A, 493B, and USB connectors 495A-B, and a “Test My Luck” button 479. Devices 410, 420, 425, 430, 441, 450, 460, 470, 471, 472, 473, 475, 478, 480, 481, 483, 485, 491, 492, 493A-B, and 495A-B shown in FIG. 4 are similar to devices 310, 320, 325, 330, 341, 350, 360, 370, 371, 372, 373, 375, 378, 380, 381, 383, 385, 391, 392, 393A-B, and 395A-B, respectively, shown in FIG. 3. The “Test My Luck” button 479 may be used as an indicator for luckiness. By pressing “Test My Luck” button 479, display device 440 may periodically display a sequence of a plurality of colors over a certain period of time and stop at one final color that may serve as an indicator for luckiness. In general, “Test My Luck” button 479 may support the following methods for luckiness testing:

(1) One Final Color Indication Method:

This method is designed to make a fast and easy luckiness testing. When a user presses the “Test My Luck” button 479, the display device 440 will flash more than one color periodically within a certain period of time. The color changing speed between different colors will decrease over time. After a while, the display device 440 will stop changing colors and stay with one final color. The final color may serve as the indicator for the luckiness the user is looking for. For example, we may use the following two colors, say green and brown, for luckiness testing. While the green color may indicate lucky, the brown color may be associated with unlucky. After a user press the presses “Test My Luck” button 479, the display device 440 will switch between the green and the brown color. The switching speed between the green and the brown color decreases over time so that it stops at one color. If the final color shown by the display device 440 is green, the user may consider this as a lucky indication, the user may consider it unlucky if the final color is brown. We may use more colors for indicating more levels of luckiness. For example, we may want to use the following five colors, such as bright green, green, yellow, dark orange, and brown, for indicating the following five luckiness levels, such as very lucky, lucky, normal, unlucky, very unlucky, respectively. In this case, after the button press of button 479, the display device 440 will switch display colors among the five mentioned colors. The switching speed among the five colors may also decrease over time so that it may finally stop at one color, which indicates the level of luckiness for the tester.

The colors mentioned serve only illustration purposes. Color choices may be different, even very different for different geographical, religious, and cultural regions in the world. The final color as the luckiness indication may be determined randomly so that a user will not get deterministic answers from the apparatus 400. However, the following three probability distribution models may be used for the final color selection:

(a) Equal probability distribution for each color:
In this case, all colors have an equal probability to be selected as the final color. That means each color has an equal chance to be stopped at or selected as the final color.

(b) Non-equal probability distribution for each color:
In this case, we may assign different probabilities to different colors. For example, a high probability may be assigned to the color with normal luckiness level, because most events and times do have a normal luckiness level. In contrast, a low probability may be assigned to the color with high luckiness level, because the high luckiness level should not occur as often as the normal luckiness level. Similarly, a very low probability may be assigned to the most unlucky color, because the most unlucky events or times should occur very infrequently. A wide range of different probability distribution models may be used depending on design and application needs.

(c) Probability distribution for each color influenced by the luckiness of the time when such a luckiness test is performed:
In this case, probability distribution assigned to each color may be influenced by the luckiness of the time when the “Test My Luck” button 479 is pressed.

For example, if the time is determined to be a lucky time when such a luckiness test is requested, it makes more sense to increase the probability for the colors associated with “very lucky” and “lucky” luckiness levels, while decreasing the probability for the colors associated with “very unlucky” and “unlucky”. Similarly, when a user presses the “Test My Luck” button 479 at an unlucky time, the probability for the colors associated with “very lucky” and “lucky” will decrease, while the probability for the colors associated with “very unlucky” and “unlucky” will increase. Other ways of influences may also be used depending on design and application needs.

(2) Final Color Prediction Method:

This method is designed to make a luckiness testing based on personal color prediction. This method uses a few colors, displays and switches between them, a user predicts the final color during the color switching period, and the method selects randomly one of the colors as the final color. If the user predicts the same color as the final color displayed, it is considered to be lucky. The same final color prediction may be performed more than once. A user may be considered as more lucky or less lucky depending on how many times his or her final color predictions were made correctly.

(3) Final Color Sequence Prediction Method:

This method is designed to make a luckiness testing based on personal color prediction for more than one final color. Instead of just prediction, the final color in the final color prediction method, this method requires a user to predict a sequence of a few colors. For example, we may use two colors, such as red and green, for color sequence prediction. Assuming the color sequence length is three, the user needs to predict the final colors in the next five luckiness tests. The user may need to predict three coming final colors, such as green, green and red, as the final color sequence. If the user presses the “Test My Luck” button 479 three times, and gets three final colors correctly in sequence as predicted, this may be considered to be lucky.

Although the “Test My Luck” button 479 in FIG. 4, has been shown as a separate button, the button 479 may be replaced by or its function may be mapped to an existing button on the user interface device 470 so that a separate button is no longer needed. In addition, the size, the shape, and the location of the button 479 may also vary depending on application and design needs. Those modifications are hereby included.

Apparatuses 100, 200, 300, and 400 may be powered by batteries, a USB connector, or a DC power source. Because apparatuses 100, 200, 300, and 400 according to the present invention do not consume a large amount of electricity, a USB connector or a few batteries may provide sufficient power. When apparatuses 300 and 400 are powered and connected to a USB connector from a computer, the USB connectors 395A-B and 495A-B may also provide data services so that they may be used to attach USB devices, such as a USB based mouse or keyboard, to the computer.

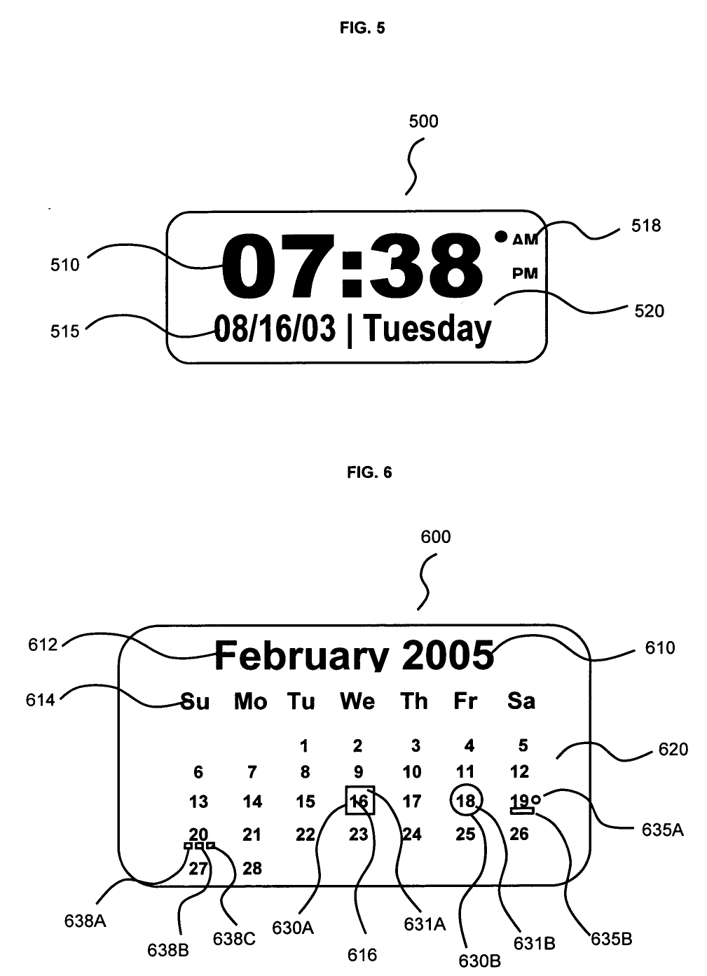

There are many types of devices that can display time. A device that can display time may include a cellular phone, a regular phone, a personal digital assistant (PDA), a portable music player, a portable computer, a personal computer, a radio with clock, a digital camera, a video camera, a video player, or any other electronic device with a built-in timing device. In general, such a device has a display panel that can display time or a calendar, as well as a wide range of other types of information. For those devices, we may have the following two options to show luckiness: We can either use a separate color display device, such as devices 140, 140A-D, 240, and 340, to show special colors or color patterns that are associated with luckiness, or an integrated color display device that can control the color of the foreground and the background of a time or a calendar display. In at least one embodiment of the present invention the apparatus is comprised of a device that can display time and a color display device that controls the background color or the foreground color of its display based on time and one or more information sources. A frontal view of a typical time and date display of a device that can display time is shown in FIG. 5. FIG. 5 shows a time and date display 500 comprised of a time display 510, a date display 515, an AM/PM display 518, and a background display 520. The AM/PM display 518 may be omitted if a user uses a twenty-four hours per day display. The characters and symbols shown in displays 510, 515, and 518 are considered to be the foreground display. There are two common types of displays, bright (illuminated) background with dark foreground, or dark background with bright (illuminated) foreground. For the first type of display with bright (illuminated) background, we can simply replace a one-color lighting device commonly used by such displays with a multi-colored lighting source that can illuminate the background, such as 520 shown in FIG. 5, with different colors or color patterns according to luckiness. For example, if a green or a red color is selected to be an indicator for luckiness, the background of a time display, such as time and date display 500, will be illuminated by green or red light from the multi-colored lighting source when a lucky day or time comes. When an unlucky day or time comes, an unlucky color that is associated with unlucky days or times, will be used to illuminate the background of the time and date display 500 so that the whole display 500 appears to have an unlucky color. By doing so, a separate color display device for showing different colors and color patterns may be omitted. This could be useful for small portable devices with no or less extra spaces for hosting a separate color display device. Similarly, for the second type of display with bright (illuminated) foreground, we can again replace a one-color lighting device that illuminates the foreground characters, such as in displays 510, 515, and 518 shown in FIG. 5, with a multi-colored lighting source that can illuminate the time and date display 500 with different colors or color patterns according to the luckiness.

Similar to the time and date display 500 shown in FIG. 5, an integrated color display device may also be used by a calendar display 600 shown in FIG. 6. FIG. 6 shows the calendar display 600 comprised of a year display 610, a month display 612, a week display 614, a day display 616, and a background display 620. Since a calendar display usually shows a plurality of days at once, the present invention, in one embodiment needs to be able to show individual colors for every day displayed. A small neighborhood region surrounding each day, such as 630A or 630B, may be used to show individual colors. A color display device may change the color of each character displayed, such as 616, or each small neighborhood background surrounding each day, such as 631A or 631B, or each small indicator located near each day, such as 635A or 635B. Two common shape examples, 630A and 630B, of the small neighborhood region surrounding each day are shown in FIG. 6. Other sizes and shapes of the small neighborhood region may also be used. In addition, two examples, 635A or 635B, of a small indicator located near each day are shown in FIG. 6 for illustration purpose only. The location as well as the shape of the indicator may also be changed depending on actual application and design needs. When multiple small indications are needed for each day, a plurality of small indicators may be used and placed near each day, such as 638A-C shown in FIG. 6. Each small indicator may display the luckiness of each day for a given subject, such as Love/Marriage, Health, and Wealth. The plurality of small indicators may also be combined with a small neighborhood region, such as 630A or 630B, to display the overall luckiness of a day, as well as luckiness for each subject.

The “Test My Luck” button 479 shown in FIG. 4 may also be used and integrated into devices that can display time, like cellular phones, handheld computing devices, personal digital assistant devices, notebooks or desktop computers. A device that can display time is comprised of a display device that is at least capable of displaying time and/or calendar, as shown in FIG. 5 and FIG. 6, respectively, in addition to other content display capabilities. Since all devices that can display time usually have user interface devices, such as real or screen based keypads or control pads for small portable devices, and keyboards and mousses for notebook and desktop computers, a “Test My Luck” button like button 479 shown in FIG. 4 may easily be added as a separate button to the user interface devices, or be mapped to an existing button on the user interface devices. Several methods in accordance with embodiments of the present invention enable display of the final colors after a button press:

(1) Whole Screen Background Color Display:

The background color of the whole screen of such a device is used to display various colors. For example, if two colors are used for luck testing, the background color of the whole display screen of such a device will switch between the two colors for a certain time period and stop at a final color. This method can be implemented in devices with mono-chrome LCD (liquid crystal display) screens with background lighting. Low-end cellular phones and regular phones, radios are typical examples of devices that have such mono-chrome LCD screens and in which this method can be implemented.

(2) A Screen Region Color Display:

A dedicated region of a screen of a device having a screen region color display is used to display various colors. For example, if two colors are used for a luck testing, the color of a dedicated region of the screen of such a device will switch between the two colors for a certain time period and stop at a final color. This is a method which can be used by devices with color LCD screens. High-end cellular phones, handheld computing devices, and personal (notebook and desktop) computers are good examples of devices which can use this method.

(3) A Small Color Display Device:

A small color display device, such as a small multi-color Light Emission Diode (LED) may be used to display various colors. A good example for such a small color display device is a multi-colored incoming call indicator used in many cellular phones. The present invention can be implemented in such an existing device or built in a separate small color display device for a color display in accordance with the present invention. The small color display device may also take various shapes and be placed at various places depending on design and application needs.

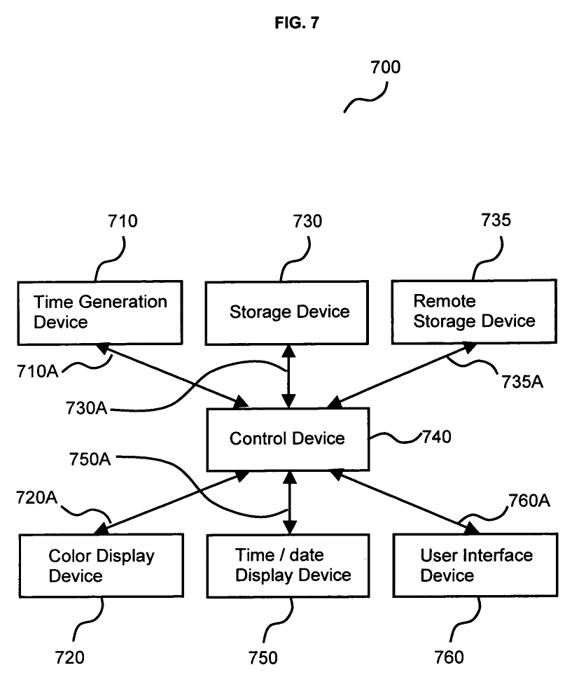

FIG. 7 is a block diagram schematically illustrating the typical devices used for one embodiment of the present invention. FIG. 7 shows apparatus 700 which includes time generation device 710, color display device 720, storage device 730, remote storage device 735, control device 740, time/date display device 750, and user interface device 760. The devices 710, 720, 730, 735, 750, and 760 are connected and communicate with control device 740 via communications links 710A, 720A, 730A, 735A, 750A, and 760A, respectively. The apparatus 700 can be used with the apparatus 100, 200, 300 or 400 of FIGS. 1A, 2, 3, or 4, respectively. Similarly named components or devices of apparatus 100, 200, 300, and 400 may be the same as similarly named components or devices of apparatus 700.

The time generation device 710 may be a typical clock chip that generates and provides time signals and calendar information. Control device 740 may be a processor or a micro-controller, or a combination of processors or micro-controllers. Some processors may also be comprised of an integrated clock chip that may also be used by the time generation device 710. In this case, a separate clock chip may be omitted. Control device 740 reads time signals from time generation device 710 via the communications line 710A. Control device 740 then uses the time signals to get the luckiness information related to the time signals from the storage device 730 via the communications line 730A. Control device 740 may further read other information, such as user preference data as well as user personal data from the storage device 730, as needed, in order to customize the luckiness information. Target colors or color patterns related to the luckiness information are then determined by the control device 740 which then sends control signals via the communications line 720A to let the color display device 720 show the target colors or color patterns. In addition to displaying colors or color patterns on the color display device 720, control device 740 may also send time information to the time/date display device 750 via the communications line 750A to show a current time and date on time/date display device 750. In general, luckiness and other information may also be stored on a remote storage device 735. Control device 740 may use the communications line 735A which may be capable of remote data access to get needed data remotely in order the update the data stored in the storage device 730 and/or to display target colors and color patterns on the color display device 720. Finally, a user interface device 760 may be used for setting up and adjustment of the time generation device 710, for inputting user preference and personal data, for color mode selection, time selection, as well as other control functions, such as turn on and turn off the color display.

Several modifications may be applied to apparatus 700 shown in FIG, 7 without departing from its basic working principle. Although the time display signals may be sent by the control device 740 to the time/date display device 750 directly, as shown in FIG. 7, it is also possible to let the time generation device 710 send time signals directly to the time/date display device 750. In addition, it is equally possible to let the user interface device 760 be connected to the time generation device 710 so that device 710 may be set and adjusted directly by a user via device 760. Another possible modification is to directly store customized luckiness information on device 730 or 735. Instead of using personal data of a user to customize the luckiness information for the user each time, it is possible to use the personal data to customize the luckiness information for the user all at once and then store the customized luckiness information on device 730 or 735. This can save some processing time by reading the customized luckiness information directly. The main drawback of this approach is that more storage spaces are needed to store both generic and customized luckiness information. Such modifications are herein incorporated.

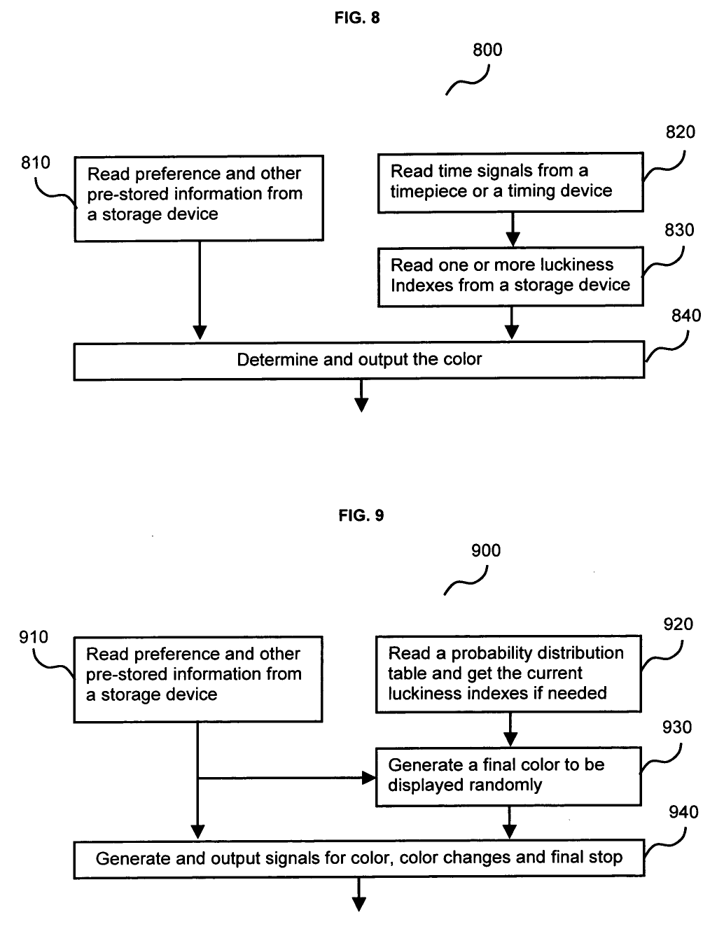

FIG. 8 depicts a signal flow diagram 800 schematically illustrating the typical steps for determining a color to be displayed by a color display device, such as devices 140, 240, 340, 440, 720 in FIGS. 1A, 2, 3, 4, and 7. As shown in FIG. 8, at step 810, preference information, such as country code, religious code, color mode, and pre-stored information, such as birthday, holidays, and color tables containing information about which color represents which luckiness level, are read from a storage device, such as storage devices 150, 250, 350, 450, and 730 and/or 735 shown in FIGS. 1A, 2, 3, 4, and 7 by a control device, such as control device 740 shown in FIG. 7. At step 820, a current time signal is read from a timepiece or a timing device, such as devices 120, 220, 320, 420, and 710 shown in FIGS. 1A, 2, 3, 4, and 7. The obtained current time signal is then used to access and get the exact luckiness indices for this time from a storage device such as one of devices 150, 250, 350,450, and 730 and 735 shown in FIGS. 1A, 2, 3, 4, and 7, at step 830. For a given time, one or more luckiness indices that are associated with this given time may be obtained. If only one luckiness index is obtained, it may be seen as a general luckiness indicator. When a plurality of luckiness indices are available, one luckiness index may be seen as a general luckiness indicator, while other indices may be viewed as special luckiness indicators for special subjects, such as love, health, and wealth. Step 840 uses the preference and pre-stored information from step 810 and the one or more luckiness indices from step 830 to determine the actual color to be displayed. For example, if the following five luckiness indices are obtained for a given period of time such as: Lucky, Lucky, Normal, Normal, Unlucky, for the following five subjects, General, Love, Health, Wealth, and Business, respectively, and the colors assigned to the luckiness indexes are, Green, Yellow, and Brown, for Lucky, Normal, and Unlucky, respectively, step 830 will determine and output the following five colors, Green, Green, Yellow, Yellow, and Brown. The colors will then be displayed by the corresponding color displays, such as devices 441, 445A-D, shown in FIG. 4.

FIG. 9 is a signal flow diagram 900 schematically illustrating the steps for generating the changing colors to be displayed by a color display device after the “Test My Luck” button has been pressed. As shown in FIG. 9, at step 910, preference and pre-stored information are at first read from a storage device, such as storage devices 150, 250, 350, 450, 730 and 735 shown in FIGS. 1A, 2, 3, 4, and 7. At step 920, a probability distribution table will then be read from a storage device. If the probability distribution needs to be modified based on current luckiness indices, luckiness indices will also be obtained at this step. The probability distribution, some relevant preference and other pre-stored information, such as the color table, from step 910, and the luckiness indices, are then used at step 930 to randomly generate a final color to be displayed. The generated final color and relevant preference and other pre-stored information are finally passed to step 940 that is responsible for generating and outputting signals for controlling the displayed colors, color changes between the displayed colors, as well as the final color to be displayed after color changes within a given period of time. The final color may be used as a luckiness predictor discussed in the previous sections. FIG. 9 depicts only one possible way for generating the control signals needed for luckiness testing. The order of the signal flow diagram 900 may change and more steps may also be added. For example, we may exchange the order between step 910 with step 920 without impacting the method according to the present invention.

Although the invention has been described by reference to particular illust embodiments thereof, many changes and modifications to the invention may become apparent to those skilled in the art without departing from the spirit and scope of the invention. It is therefore intended to include within this patent, all such changes and modifications as may reasonably and properly be included within the scope of the present invention's contribution to the art.

I claim:

1. An apparatus comprising
a timepiece;
an information source device;
a color display device;
wherein the timepiece provides time information;
wherein the information source device provides at least one information source;
wherein the color display device displays colored information based on the time information provided by the timepiece and the at least one information source.

2. The apparatus of claim 1 wherein
the colored information is comprised of at least one color.

3. The apparatus of claim 1 wherein
the colored information is comprised of at least one color pattern.

4. The apparatus of claim 1 wherein
the at least one information source provides luckiness information.

5. The apparatus of claim 4 wherein
the luckiness information is comprised of a first luckiness index for a first subject of interest.

6. The apparatus of claim 1 wherein
the color display device is comprised of a display screen of an electronic device.

7. The apparatus of claim 1 wherein
the color display device is comprised of at least one object illuminated by a at least one light source.

8. The apparatus of claim 5 further comprising
a selection device;
wherein a user may use the selection device to select the first subject of interest from a plurality of subjects of interest so that the color display device will display at least one color based on the first luckiness index related to the selected first subject of interest.

9. The apparatus of claim 1 further comprising
a time information selection device;
wherein a user may use the time information selection device to select time information of interest so that the color display device can display at least one color based on the selected time information of interest.

10. An apparatus comprising
a timepiece;
an information source device;
a color display device;
wherein the timepiece provides time information;
wherein the information source device provides luckiness information related to the time information;
wherein the color display device displays colored information based on the luckiness information.

11. The apparatus of claim 10 wherein
the luckiness information is comprised of a first luckiness index related to a first set of time information.

12. The apparatus of claim 10 further comprising
a control device;
wherein the control device uses the time information and the luckiness information to determine the colored information to be displayed by the color display device.

13. The apparatus of claim 10 further comprising
a selection device;
wherein a user may use the selection device to select a first subject of interest so that the color display device will display a color based on a luckiness index related to the first subject of interest .

14. The apparatus of claim 10 further comprising
a time information selection device;
wherein a user may use the time information selection device to select new time information of interest so that the color display device displays colors based on a plurality of luckiness indexes related to the selected new time information of interest.

15. The apparatus of claim 10 further comprising
a button;
wherein the color display device displays a sequence of colors in response to the button being pressed .

16. The apparatus of claim 10 further comprising
a color mode selection device;
wherein a user may use the color mode selection device to select desirable colors to be displayed by the color display device.

17. The apparatus of claim 10 further comprising
a personal information input device;
wherein a user may use the personal information input device to input personal information for customizing the luckiness information.

18. A method comprising the steps of
obtaining time information;
obtaining luckiness information related to the time information;
displaying colored information based on the obtained luckiness information.

19. The method of claim 18 wherein
the luckiness information is comprised of at least one luckiness index related to at least one subject of interest.

20. The method of claim 18 wherein
the colored information is comprised of at least one color.

21. The method of claim 18 wherein
the colored information is comprised of at least one color pattern.

22. The method of claim 18 wherein
the colored information is comprised of at least one colored indicator placed near a date in a calendar display;
wherein the luckiness information includes luckiness information for the date;
and wherein the at least one colored indicator is related to the luckiness information for the date.

23. The method of claim 18 wherein
the colored information is comprised of a first colored background region surrounding a date in a calendar display; and
wherein the luckiness information includes luckiness information for the date;
and wherein the first colored background region is related to the luckiness information for the date.

24. The method of claim 18 wherein
the colored information is comprised of the display color of a date in a calendar display; and
wherein the luckiness information includes luckiness information for the date;
and wherein the display color of the date is related to the luckiness information for the date.

25. The method of claim 18 further comprising
using a user's personal information to customize the luckiness information.

26. The method of claim 18 wherein
the colored information is displayed on a screen of an electronic device.

27. The method of claim 18 wherein
the colored information is displayed on at least one object illuminated by at least one light source.

28. The method of claim 18 further comprising
allowing a user to select new time information of interest for displaying colors based on luckiness indexes related to the selected new time information of interest.
